(19) United States
(12) Patent Application Publication
(10) Pub. No.: US 2010/0048139 A1
(43) Pub. Date: Feb. 25, 2010

(54) BATTERY POWER CONSUMPTION CONTROL

(75) Inventors: Dae-Wha Seo, Daegu (KR); Jong-Youl Lee, Daegu (KR); Young-Jin Nam, Daegu (KR)

Correspondence Address: THE NATH LAW GROUP, 112 South West Street, Alexandria, VA, 22314, US

(73) Assignee: KYUNGPOOK NATIONAL UNIVERSITY INDUSTRY-ACADEMIC COOPERATION FOUNDATION, Daegu (KR)

(21) Appl. No.: 11/995,521

(22) PCT Filed: Jul. 21, 2006
(86) PCT No.: PCT/KR06/02874

§ 371 Date: Apr. 17, 2009

(30) Foreign Application Priority Data
Jul. 21, 2005 (KR) 10-2005-0066168

(51) Int. Cl. H04B 17/00

(52) U.S. Cl. 455/67.11; 455/572

(57) ABSTRACT

Provided is a power control method in which a remaining battery time of a portable device can be ensured, and a portable device using the method. The power control method includes receiving externally a requested time-of-use and a type of one or more application programs to be executed; computing an estimated amount of power consumption when the application programs are executed for the requested time-of-use; measuring a remaining amount of power within the portable device; determining operation modes of elements of the portable device by using the estimated amount of power consumption and the remaining amount of power; and controlling operations of the elements according to the determined operation modes, in which the portable device allows a user to execute the application programs for the time-of-use requested by the user.

### TECHNICAL FIELD

The present invention relates to a method of controlling battery power consumption in which a remaining battery time can be ensured, and a portable device using the method of controlling power consumption, and more particularly, to a power control method for controlling battery power consumption so as to operate a portable device, such as a portable communication terminal or a personal digital assistance, for a required remaining time, and a portable device using the power control method.

### BACKGROUND ART

Recently, with the rapid development of a mobile communication technique, a cell phone or a personal digital assistance can be provided with various types of multimedia services. In order to provide such various types of multimedia services, the cell phone or the like has a larger sized display unit and higher resolution. In addition, a receiving capability of an antenna is being improved. Moreover, the number of backlights is increasing, and brightness thereof is becoming higher. As the structure of the cell phone is improved, power consumption for operating elements of the cell phone has significantly increased.

Meanwhile, the cell phone is used not only to perform simple audio communication but also to reproduce multimedia content such as a still picture, a motion picture, and a movie. When such multimedia content is reproduced, battery power consumption increases.

Accordingly, with an increase of power consumption of a portable device, various methods have been proposed to reduce power consumption of the portable device.

### DISCLOSURE

### Technical Problem

The present invention provides a power control method in which battery power consumption is controlled so that a portable device can be used for a time desired by a user.

The present invention also provides a portable device using a power control method in which the portable device can be used for a time desired by a user.

### Technical Solution

According to an aspect of the present invention, there is provided a power control method of a portable device, the method comprising steps of: (a) receiving externally a requested time-of-use and a type of one or more application programs to be executed; (b) computing an estimated amount of power consumption when the application programs are executed for the requested time-of-use; (c) measuring a remaining amount of power within the portable device; (d) determining operation modes of elements of the portable device by using the estimated amount of power consumption and the remaining amount of power; and (e) controlling operations of the elements according to the determined operation modes, wherein the portable device allows a user to execute the application programs for the time-of-use requested by the user.

According to another aspect of the present invention, there is provided a power control method of the portable device, the method comprising steps of: (a) receiving externally a requested time-of-use and a type of one or more application programs to be executed; (b) computing an estimated amount of power consumption based on predetermined operation modes for elements of the portable device when the application programs are executed for the requested time-of-use; (c) measuring a remaining amount of power within the portable device; (d) re-determining operation modes for the elements of the portable device when the estimated amount of power consumption exceeds the remaining amount of power; and (e) controlling operations of the elements according to the re-determined operation modes, wherein the portable device allows a user to execute the application programs for the time-of-use requested by the user.

According to another aspect of the present invention, there is provided a portable device composed of a central controller controlling overall operations and one more elements, wherein the central controller comprising: a user input module that receives from a user a requested time-of-use and a type of application program to be executed; an operation mode determining module that computes an estimated amount of power consumption which is required to execute the application program for the requested time-of-use, detects a remaining amount of power of the portable device, and determines operation modes of the elements by using the estimated amount of power consumption and the remaining amount of power; and an operation control module that controls operations of the elements according to the operation modes determined by the operation mode determining module.

In the aforementioned aspect of the portable device, the operation control module may comprise at least one of: a backlight dimming controller that controls a brightness level of backlight; a video resolution controller that controls video resolution; an audio level controller that controls an audio output chord level; an CPU clock controller that controls a CPU clock; and a hard disk operation controller that controls an operation mode of a hard disk.

In addition, the operation mode determining module may determine the operation modes of the above elements so that the portable device can operate for the maximum period of time.

### Advantageous Effects

A power control method according to the present invention can be used any multimedia portable devices. Examples of the portable devices include a portable communication terminal, a personal digital assistance (PDA), an MPEG3 player, a digital camera, and a camcorder.

In the past, when using a notebook computer so as to watch a movie in a condition that a remaining amount of battery power is one hour, the movie can be reproduced for the maximum one hour. However, according to the power control method of the present invention, a time for watching the movie can extend by controlling a user's preference or by selecting an automatic optimum mode, thereby controlling screen resolution or an audio decoding level.

Furthermore, when a business person tries to make an importable document in a condition that a remaining amount of battery power is 30 minutes, and if a minimum time required for making the document is one hour, then the power control method according to the present invention can be used in a relevant device. Accordingly, a CPU speed of the relevant device and brightness of backlight are controlled, and power consumption of the device which cannot be recognized by a user is controlled. Further, unnecessary background programs are terminated. Therefore, overall power consumption is minimized, and thus one hour that is required for completing the document can be ensured.

### DESCRIPTION OF DRAWINGS

FIG. 1 is a block diagram schematically illustrating a configuration of a central controller of a portable device using a power control method according to an embodiment of the present invention; and

FIG. 2 is a flowchart sequentially illustrating a power control method of a portable device according to an embodiment of the present invention.

### BEST MODE

Hereinafter, a power control method of a portable device according to an embodiment of the present invention will be described in detail with reference to the accompanying drawings.

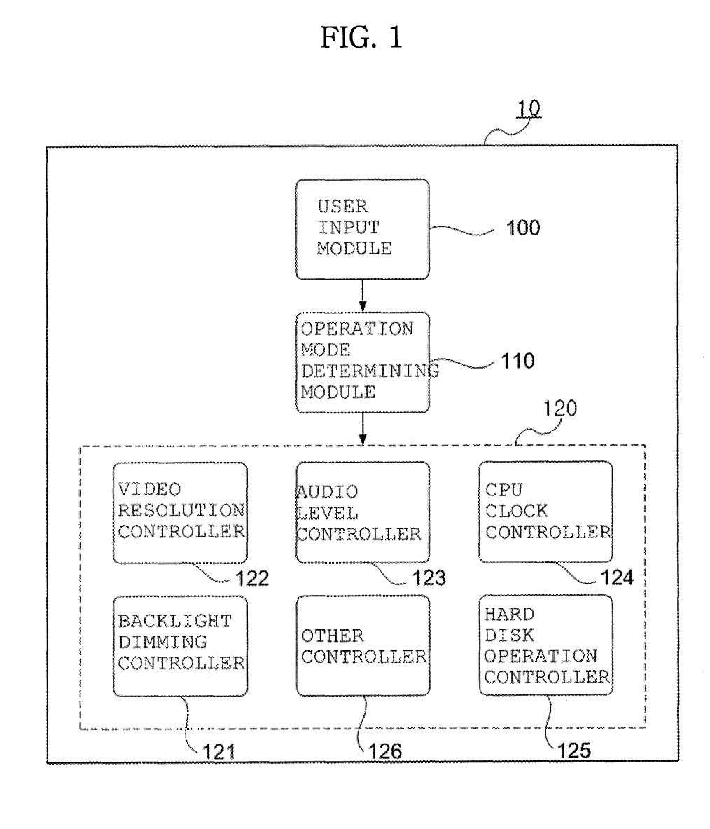

FIG. 1 is a block diagram schematically illustrating a configuration of a central controller 10 of a portable device using a power control method according to an embodiment of the present invention.

In general, the portable device is composed of a plurality of elements and a central controller that controls operations of the elements. This embodiment of the present invention is related to the configuration and operation of the central controller 10 of the portable device. Now, the configuration and operation of the central controller 10 will be described in detail with reference to FIG. 1.

Referring to FIG. 1, the central controller 10 includes a user input module 100, an operation mode determining module 110, and an operation control module 120.

The user input module 100 receives from a user a requested time-of-use and a type of an application program to be executed by using an input/output means of the portable device. Further, the user input module 100 allows the user to selectively input a user's preference such as a backlight dimming level, video resolution, and an audio output chord level, or to select an automatic optimum mode by using a menu screen.

According to the input user's preference, the operation mode determining module 110 computes an estimated amount of power consumption which is required to execute the application program for the requested time-of-use, and detects a remaining amount of power of the portable device. Then, by using the estimated amount of power consumption and the remaining amount of power, the operation modes of the aforementioned elements are determined.

When the automatic optimum mode of the user input module 100 is selected, the operation mode determining module 110 further includes a maximum time computing unit. The maximum time computing unit determines the operation modes of the elements of the portable device so that the portable device can operate for the maximum period of time.

According to the operation modes determined by the operation mode determining module 110, the operation control module 120 controls the operations of the elements. The operation control module 120 includes a backlight dimming controller 121 that controls a brightness level of backlight, a video resolution controller 122 that controls resolution of a display unit, an audio level controller 123 that controls an output chord level of a speaker, a central processing unit (CPU) clock controller 124 that controls a CPU clock, a hard disk operation mode controller 125 that controls an operation of a hard disk according to an operation mode thereof, and an operation controller 126 that controls the rest of other elements.

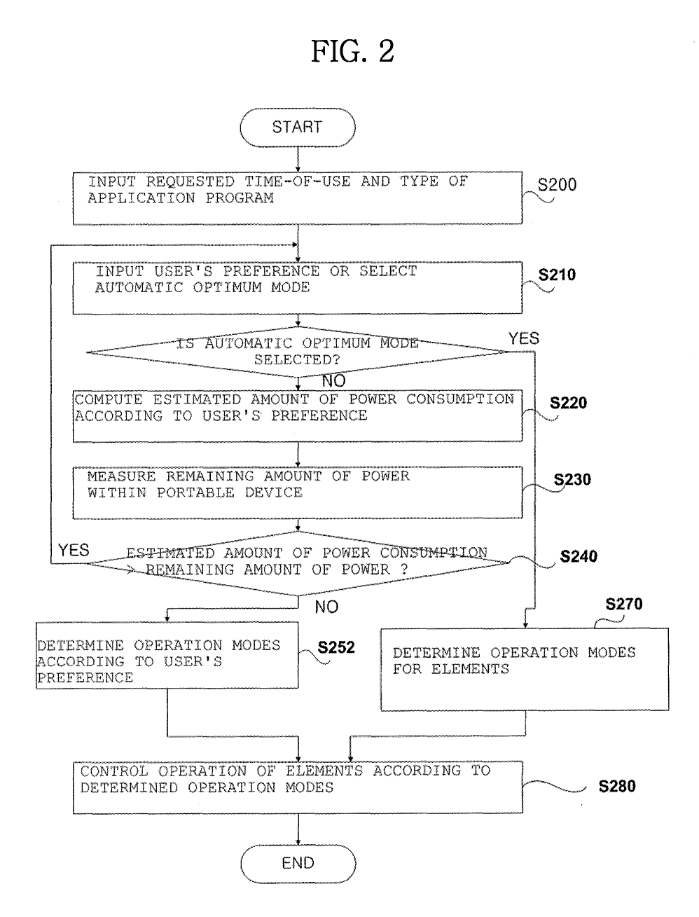

Now, a power control method which is executed by the central controller 10 having the aforementioned configuration will be described in detail with reference to FIG. 2. FIG. 2 is a flowchart sequentially illustrating the power control method.

Referring to FIG. 2, a user first input a requested time-of-use and a type of at least one of application programs to be executed (step 200). Further, the user inputs a user's preference, or selects an automatic optimum mode (step 210).

If the automatic optimum mode is not selected in step 210, an estimated amount of power consumption is computed on the basis of a predetermined operation mode for elements of the portable device when the application program is executed for the requested time-of-use and on the basis of the user's preference (step 220), and a remaining amount of power within the portable device is measured (step 230). Next, the estimated amount of power consumption is compared with the remaining amount of power (step 240). If the estimated amount of power consumption exceeds the remaining amount of power, a message is displayed on a display unit so as to inform the user of the result thereof. Thereafter, returning back to step 210, the user inputs the user's preference again, or selects the automatic optimum mode (step 250).

If the estimated amount of power consumption does not exceed the remaining amount of power, the operation mode of the portable device is determined according to the user's preference (step 252).

If the user selects the automatic optimum mode in step 210, the operation modes of respective elements are determined so that the portable device can operate for the maximum period of time, and the user is informed of an estimated maximum operating time. Further, the operation modes related to the resolution, the output chord, the backlight are determined to be minimum power consumption modes (step 270), and thus the portable device can operate for the maximum period of time.

Next, the operations of the elements are controlled according to the determined operation modes (step 280).

According to the present invention, a portable device can operate for a time-of-use that is requested by a user.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

### INDUSTRIAL APPLICABILITY

A power control method according to the present invention can be significantly useful in a portable device or a handheld device which needs to be operated as long period of time as possible with small battery capacity.

1. A power control method for a portable device, the method comprising steps of:
(a) receiving externally a requested time-of-use, a type of one or more application programs to be executed, and a user's preference;
(b) computing an estimated amount of power consumption when the application programs are executed for the requested time-of-use;
(c) measuring a remaining amount of power within the portable device;
(d) determining operation modes of elements of the portable device by using the estimated amount of power consumption and the remaining amount of power; and
(e) controlling operations of the elements according to the determined operation modes,
wherein the operation modes for the elements of the portable device are determined according to the user's preference when the operation modes are determined in the step (d), and
wherein the portable device allows a user to execute the application programs for the time-of-use requested by the user.

2. A power control method for a portable device, the method comprising steps of:
(a) receiving externally a requested time-of-use, a type of one or more application programs to be executed, and a user's preference;
(b) computing an estimated amount of power consumption based on predetermined operation modes for elements of the portable device when the application programs are executed for the requested time-of-use;
(c) measuring a remaining amount of power within the portable device;
(d) re-determining operation modes for the elements of the portable device when the estimated amount of power consumption exceeds the remaining amount of power; and
(e) controlling operations of the elements according to the re-determined operation modes,
wherein the operation modes for the elements of the portable device are determined according to the user's preference when the operation modes are determined in the step (d), and
wherein the portable device allows a user to execute the application programs for the time-of-use requested by the user.

3. The power control method according to claim 1, wherein, in the step (a), a user inputs one or more user's preferences including a backlight dimming level, video resolution, and an audio chord level, or selects an automatic optimum mode.

4. The power control method according to claim 2, wherein, in the step (a), a user inputs one or more user's preferences including a backlight dimming level, video resolution, and an audio chord level, or selects an automatic optimum mode.

5. The power control method according to claim 4, wherein, in the step (a), if the user selects the automatic optimum mode, the operation modes for the elements of the portable device are determined so that the portable device can operate for the maximum period of time.

6. A portable device having a central controller controlling overall operations and one or more elements, the central controller comprising:
a user input module that receives from a user a requested time-of-use and a type of application program to be executed;
an operation mode determining module that computes an estimated amount of power consumption which is required to execute the application program for the requested time-of use, detects a remaining amount of power of the portable device, and determines operation modes of the elements by using the estimated amount of power consumption and the remaining amount of power; and
an operation control module that controls operations of the elements according to the operation modes determined by the operation mode determining module,
wherein the operation mode determining module further comprises a maximum time computing unit that determines the operation modes of the elements of the portable device so that the portable device can operate for the maximum period of time.

7. The portable device according to claim 6, wherein the operation control module comprises at least one of:
a backlight dimming controller that controls a brightness level of backlight;
a video resolution controller that controls video resolution;
an audio level controller that controls an audio output chord level;
an CPU clock controller that controls a CPU clock; and
a hard disk operation controller that controls an operation mode of a hard disk.
